(19) United States
(12) Patent Application Publication
(10) Pub. No.: US 2024/0061313 A1
(43) Pub. Date: Feb. 22, 2024

(54) EXTENDED DEPTH RANGE LIGHT FIELD DISPLAY

(71) Applicant: Google LLC, Mountain View, CA (US)

(72) Inventor: Gang He, Cupertino, CA (US)

(21) Appl. No.: 18/259,521

(22) PCT Filed: Dec. 28, 2021
(86) PCT No.: PCT/US21/65368

§ 371 Date: Jun. 27, 2023

Related U.S. Application Data
(60) Provisional application No. 63/131,668, filed on Dec. 29, 2020.

(51) Int. Cl. G02F 1/29; G02B 30/10

(52) U.S. Cl. CPC G02F 1/294; G02B 30/10

(57) ABSTRACT

A light field display for providing multiple light field views includes a sub-raxel array including a plurality of sub-raxels. The light field display further includes a microlens array in optical communication with the sub-raxel array, the microlens array including a plurality of tunable microlenses, and a spatial light modulator (SLM) in optical communication with the microlens array. A dimension of each one of the plurality of tunable microlenses is larger than a corresponding dimension of each one of the plurality of sub-raxels, and at least a portion of the plurality of tunable microlenses is tunable. The microlens array may be located between the sub-raxel array and the SLM.

### CROSS-REFERENCE TO RELATED APPLICATIONS

This application claims priority to U.S. Provisional Application No. 63/131,668 filed Dec. 29, 2020, the entire content of which is incorporated herein by reference.

### BACKGROUND OF THE DISCLOSURE

Aspects of the present disclosure generally relate to light field displays, and more specifically, to light field displays that have an extended depth of view.

With the advent of different video applications and services, there is a growing interest in the use of displays that can provide an image in full three dimensions (3D). Existing display technologies can have several limitations, including limitations on the views provided to the viewer, the complexity of the equipment needed to provide the various views, or the cost associated with making the display. Light field displays (LFDs) present some of the better options for use as a 3D display as they can be flat displays configured to provide multiple views at different locations to enable the perception of depth or 3D to a viewer. In one example, LFDs include light emitting elements capable of providing light signals with controllable amplitude and directionality to project images at multiple focal planes over a 3D volume rather than on a single two-dimensional (2D) surface. In another example, multiple 2D layers of transmissive displays (e.g., liquid crystal displays) are stacked such that each 2D layer displays an image corresponding to its layer depth within the stack, thus creating a 3D viewing experience for the viewer.

As used in this disclosure, the term “raxel” refers to a group of light emitting elements, each light emitting element producing light in a particular wavelength range of the electromagnetic spectrum. Each light emitting element may also be referred to as a “sub-raxel.” In an example, each sub-raxel produces a single color of light such as red, green, or blue light. In another example, multiple sub-raxels are monolithically integrated on a semiconductor substrate. In other words, an arrangement of sub-raxels that are organized, grouped, or otherwise organized into groups may be called a raxel. For example, a group of three sub-raxels capable of emitting light at red (R), green (G), and blue (B) wavelengths, respectively, may form a RGB raxel. Furthermore, a group of raxels may be organized into a picture element or “super-raxel.” As an example, an array of multiple RGB raxels (each raxel including three sub-raxels emitting at red, green, and blue wavelengths, respectively) may form a super-raxel.

A super-raxel, also referred to as a “picture element” or a “pixel” to describe a structural unit in a light field display in the present disclosure, is different from a pixel in a traditional display in that a pixel in a traditional display generally identifies a single light emitting element that emits light in a non-directional manner while a super-raxel (i.e., pixel or picture element in the present context) further includes a plurality of individual light emitting elements (i.e., multiple raxels with including sub-raxels). Moreover, arrays of super-raxels can be included in a light field display to simultaneously produce multiple, different light field views. In certain embodiments, control over the directionality of the light emission from each of the super-raxels is provided by a light steering optical element (e.g., a microlens, a lenslet, gratings, or a combination thereof). As an example, a light field display may include an array of super-raxels optically connected with an array of microlenses serving as light steering optical elements. Each of the sub-raxels, raxels, and/or super-raxels and corresponding light steering optical elements may be individually addressed by electronic drive circuitry formed, for example, on an integrated or separate backplane electronically connected with the light emitting elements.

One difficulty of light field displays is the limitation in the depth of field that may be presented by the display due to pixel diffraction. In certain applications, even when pixel-level diffraction may be optically overcome, the angle of view may be limited such that the light field display may only be used for near-eye applications (e.g., smart glasses and goggle-mounted displays). It would be desirable to alleviate such known problems of light field displays to enable their use in a wider range of applications and viewing situations.

### SUMMARY OF THE DISCLOSURE

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its purpose is to present some concepts of one or more aspects in a simplified form as a prelude to the more detailed description that is presented later.

The disclosure describes various aspects related to a light field display with an extended depth range. In an aspect, a first architecture of this type of display is referred to as a dual-layer display (DLD) and includes a pixel raxel array, a tunable array of microlenses, and a spatial light modulator (SLM). A size of each microlens is larger than a size of each pixel in the pixel array.

In another aspect, a second architecture of this type of display is referred to as a double-integral-imaging (DII) display and includes a pixel array, a tunable array of nanolenses, and a tunable array of microlenses. A size of each microlens is larger than a size of each pixel in the pixel array.

In another aspect, a light field display for providing multiple light field views to a viewer is described. The light field display includes a sub-raxel array including a plurality of sub-raxels, and a microlens array in optical communication with the sub-raxel array. The microlens array includes a plurality of microlenses. The light field display further includes a spatial light modulator (SLM) in optical communication with the microlens array. A size of each one of the plurality of microlenses is larger than a size of each one of the plurality of sub-raxels. Further, at least a portion of the plurality of microlenses is tunable such that at least one light field view produced by the sub-raxel array is projected at a focal plane selected within a first range of depth of view. The first range of depth of view is wider than an unmodified depth of view provided if the portion of the plurality of microlenses is not tunable.

In another aspect, a light field display for providing multiple light field views is disclosed. The light field display includes a sub-raxel array, a nanolens array in optical communication with the sub-raxel array, and a microlens array in optical communication with the nanolens array. The nanolens array includes a plurality of nanolenses, at least a portion of which plurality of nanolenses is tunable. The microlens array includes a plurality of microlenses, and at least a portion of the plurality of microlenses is tunable. A size of each one of the plurality of microlenses is larger than a size of each one of a plurality of sub-raxels of the sub-raxel array. Further, each one of the plurality of nanolenses is smaller than a size of each one of the plurality of microlenses. Additionally, the sub-raxel array, nanolens array, and microlens array are configured for cooperating such that at least one light field view produced by the sub-raxel array is projected at a focal plane selected within a first range of depth of view. The first range of depth of view is wider than an unmodified depth of view provided if the portion of the nanolenses and the portion of the microlenses were not tunable.

### BRIEF DESCRIPTION OF THE DRAWINGS

The appended drawings illustrate only some implementation and are therefore not to be considered limiting of scope.

FIG. 1 illustrates an example of a light field display.

FIG. 2 illustrates an example of a cross-sectional view of a portion of a light field display.

FIG. 3 illustrates an example of different zones to display an image using an extended depth range (EDR) light field display, in accordance with aspects of this disclosure.

FIG. 4 illustrates an example of a double-integral-imaging light field display (DII-LFD) architecture for an EDR light field display, in accordance with aspects of this disclosure.

FIG. 5 illustrates an example of a dual-layer display light field display (DLD-LFD) architecture for an EDR light field display, in accordance with aspects of this disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in diagram form in order to avoid obscuring such concepts.

This disclosure describes techniques to address the diffraction phenomena and extend the range of depth to a wider range within which the image is clear and sharp, while taking advantage of the high resolution configuration of sub-raxels organized into raxels, in turn organized into super-raxels. In this regard, this disclosure describes an extended depth range (EDR) light field display, which advantageously combines certain features or functionality of the integral imaging light field display and the multi-focal-plane (M P) light field display discussed above to overcome the previously discussed issues inherent in light field displays for projection of 3D images.

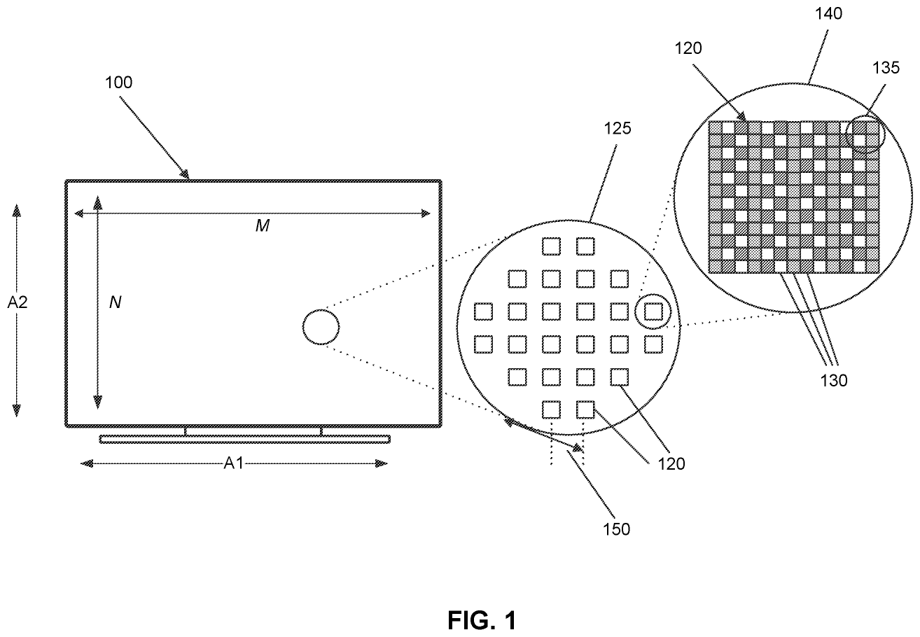

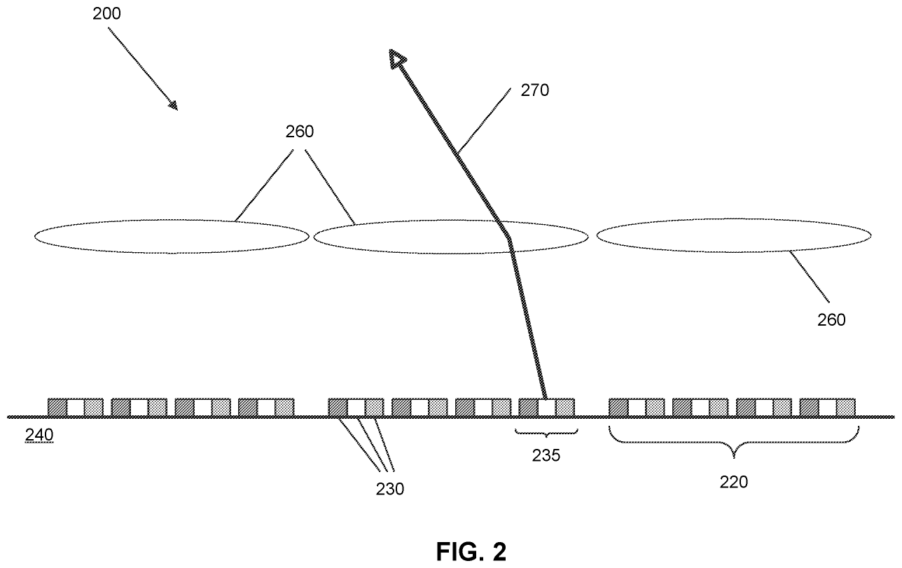

FIG. 1 shows an example light field display 100 including an N-by-M array of super-raxels 120, with N being the number of rows of super-raxels and M being the number of columns of super-raxels in the array. The N rows and M columns are along respective axes A2 and A1. An exemplary layout of super-raxels 120 within light field display 100 is shown in an inset 125. Similarly, an exemplary layout of sub-raxels 130 and organized into a plurality of raxels 135 are shown in an inset 140. Each one of super-raxels 120 includes its corresponding light steering optical element (e.g., a separately- or integrally formed imaging lens, discussed later in FIG. 2). In the example shown in FIG. 1, each super-raxel 120 is separated from each other super-raxel 120 by a pitch 150, measured from the center of each super-raxel to the center of each adjacent super-raxel. Each super-raxel 120 includes an array of raxels 135, which are in turn formed of a plurality of adjacent sub-raxels 130, in the example shown in FIG. 1.

Light field display 100 can be used for different applications and its size may vary accordingly. For example, light field display 100 can have different sizes and numbers of super-raxels when used as displays for watches, near-eye applications, phones, tablets, laptops, monitors, televisions, and billboards, to name a few. Accordingly, and depending on the application, super-raxels 120 in light field display 100 can be organized into arrays, grids, or other types of ordered and non-ordered arrangements of different sizes.

FIG. 2 shows a cross-sectional view of a portion of a light field display 200 to illustrate some of the structural units described above with respect to FIG. 1. For example, light field display 200 includes adjacent super-raxels 220, each super-raxel 220 including a plurality of sub-raxels 230 organized into a plurality of raxels 235 and disposed on a substrate 240. Each super-raxel 220 is in optical communication with a light steering optical element 260. Each light steering optical element 260 can be separately or integrally formed from super-raxel 220. As an example, one of light steering optical elements 260 is configured for directing light emitted from each sub-raxel 230 in a particular direction, as represented by a ray element 270. Light steering optical element may be further configured for directing light emitted from a different raxel 235 within the same super-raxel 220 in a different direction from ray element 270.

Such a light field display configuration, in which light emission from different light emitting elements are directed at different angles by a lens array, is generally called an integral imaging display. While integral imaging displays provide an effective way of projecting multiple views of an object, thus providing 3D imaging, they encounter problems as the size of the sub-raxels, and correspondingly raxels and super-raxels, are reduced. For instance, when the size of the raxel approaches the diffraction limit, as would be desirable in high resolution 3D displays, the smallest image size resolvable by a viewer's pupil, and thus the depth of view providable by the light field display, becomes diffraction limited.

In other words, when the size of the raxels and their corresponding light steering optical elements become smaller than the smallest resolvable image size for the human eye, the depth of view, and thus the depth of the 3D image provided by the system, becomes limited when the image is projected away from the light field display. In an example, the diffraction limit dictates how sharp an image can be projected over a range of depth of view when projected away from the light field display.

An alternative approach to the integral imaging display is a multi-focal plane approach, in which projection optics are provided at the system level to project images at multiple focal planes from two or more independent light emitting systems. At least theoretically, the multi-focal plane approach provides unlimited depth of view because the projection optics are not provided at the raxel or super-raxel level such that there is no pixel-level diffraction issue. In other words, the size of the optics in the multi-focal plane approach, including the light emitting elements and any light steering optics, is much larger than the diffraction limit.

However, the multi-focal plane approach is limited in the viewable image angle (e.g., usually to head-mounted displays or other near-eye imaging situations) unless a mechanism to reconcile occlusion is provided to help the viewer process image depth information. Occlusion refers to the situation where a foreground object is blocking the view of a background object. To produce a 3D image of both the foreground and background objects, the display system must account for the fact that the portion of the background object blocked by the foreground object depends on the viewpoint of the viewer. That is, if the perspective of the viewer moves, then different parts of the background object should be blocked by the foreground object, or otherwise the viewer experiences visual dissonance. This situation is difficult to handle for multi-focal plane system because the occlusion must be taken into account over several stacked images at different focal planes. While the occlusion problem is more readily addressed if the viewer perspective is fixed and known, such in near-eye imaging applications, this problem limits the potential applications of the multi-focal plane approach for light field displays.

The EDR light field display configurations described in this disclosure combines aspects of the angle of view manipulation of the integral imaging approach with the depth of view advantages of the multi-focal-plane approach. That is, aspects of the integral imaging approach are used to provide flexible, direct viewing to avoid the occlusion problem of the multi-focal plane approach, while aspects of the multi-focal plane approach are used to overcome the diffraction limits of the integral imaging approach. In other words, the EDR light field display described herein is able to produce multiple focal planes not limited by pixel diffraction, where each focal plane is an integral imaging light field to create the full light field even with occlusion.

In one approach, the projection optics used in the EDR light field display are multiplexed in time such that the EDR light field display sweeps through a range of image depth over time, thus providing image projection over a range of focal planes in the course of the sweep. In other words, the images produced by integral imaging can be swept through a range of focal planes over a time period such that the resulting EDR light field display is capable of displaying 3D images with extended depth of range and improved angular viewing performance as compared to the traditional integrated imaging approach or the multi-focal plane approach alone.

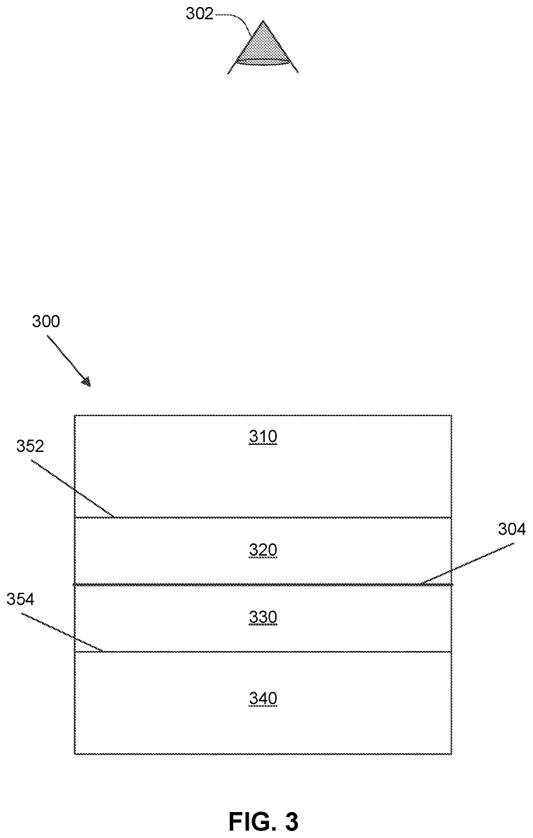

An example of a focal plane sweeping approach is illustrated in FIG. 3, in accordance with an embodiment. FIG. 3 shows a representation of depth of view zones 300 as viewed by a viewer 302 (represented by an eye). From a zone closest to viewer 302, an EDR light field display 304 provides multiple views throughout depth of view zones 300, which may be divided into a front far-field zone 310, a front near-field zone 320, a rear near-field zone 330, and a rear far-field zone 340, which is farthest from viewer 302 as shown in FIG. 3. In an example, EDR light field display 304 may be configured for providing a focused foreground image at a plane within front far-field zone 310 such that a minimum lens aperture is proportional to the image projection distance to reduce diffraction limit. Similarly, EDR light field display 304 may be configured for providing a focused background image at a plane within rear far-field zone 340 by sweeping an effective focal plane of EDR light field display 304 from front far-field zone 310 to rear far-field zone 340. This focal-plane sweep can be performed, for example, by providing a system of tunable lenses for directing light from individual or groups of light emitting elements, as will be discussed in further detail hereinafter.

In order to focus an image in a plane within front near-field zone 320, EDR light field display 304 projects the image at a front interface 352 between front far-field zone 310 and front near-field zone 320, then adjusts the aperture of EDR light field display 304 (e.g., light steering optical elements as shown in FIG. 2) to bring the image to a focus at the desired plane within front near-field zone 320. Similarly, in order to focus an image in a plane within rear near-field zone 330, EDR light field display 304 projects the image at a rear interface 354, then adjust the aperture of EDR light field display 304 to bring the image to a focus at the desired plane within rear near-field zone 330. In this way, EDR light field display 304 is able to project an image at focal planes throughout depth of view zones 300.

In the example shown in FIG. 3, the focal-plane sweep may involve a sweep equivalent to 0.2 Diopters (D) per plane. Further, the integral imaging approach may allow imaging in rear and front near-field zones 330 and 330, respectively, if the rear and front near-field zones are within the diffraction-limited depth of view of ±0.14 D, thus essentially defining a minimum focus gap. Such an approach to achieving an EDR light field display by combining the integrated imaging and multi-focal plane approaches allows additional considerations in the mapping of a light field function to images the EDR light field display to mitigate, for example, occlusion effects related to changes in the occlusion of background scenes by a foreground object as the viewer's perspective is moved. For instance, if an object is intended to be obscured by a blocking object placed in front of it, the blocking object can be represented in the sub-function corresponding to a foreground plane such that the object will appear to be occluded by the blocking object when viewed by viewer 302. Similarly, if the object is intended to obscure a blocked object placed behind it, the blocked object can be represented in the sub-function corresponding to a background plane such that the blocked object will appear to be occluded by the object to viewer 302.

Alternatively, a different algorithm may be used to separate the object light field function into multiple sub-functions according to other parameters. For example, the sub-functions corresponding to different focal planes may include redundant information, such as known foreground or background data. Thus, occlusion processing may be limited to edges of known blocking objects in the foreground and/or known objects such that background information at occlusion edges of the known blocking objects in the foreground can also be assigned to the foreground for image processing. Furthermore, decomposition of the light field function into multiple sub-functions can be based on image distance or other parameters for specific EDR light field display application.

When the linear object is projected to plane in zones 320 and 330 at a viewing distance near EDR light field display 304, the corresponding light field functions are again different in these zones. That is, the representation of the linear object in front near-field 320 as well as the sub-functions corresponding to foreground and background planes may be quite different from the sub-functions of other viewing zones. There may still be redundancies in the information contained in the light field functions, such as the location of the linear object with respect to foreground and background light field functions, which can simply the image processing algorithms. Further, light field function of an object projected at a rear infinity plane may be collapsed to a single focal plane, as there would be no further background object that could be occluded by the linear object, and it is assumed any object in a plane in front (closer to viewer 302) would occlude the linear object at rear infinity, thus simplifying the image processing.

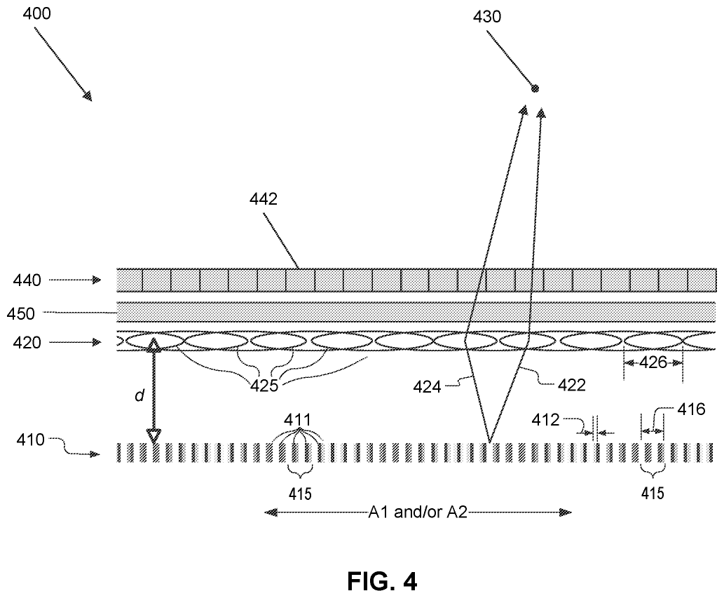

One exemplary configuration of an EDR light field display for implementing the focal plane sweep approach is illustrated in FIG. 4, in accordance with an embodiment. As shown in FIG. 4, an EDR light field display 400 includes a sub-raxel array 410, such as an array of sub-raxels illustrated for example in FIGS. 1 and 2. As were shown in FIGS. 1 and 2, groups of sub-raxels within sub-raxel array 410 may be organized into raxels, and larger arrays of raxels may be configured into super-raxels. A tunable microlens array 420 is disposed at a distance d from sub-raxel array 410 such that light rays 422 and 423 produced by different sub-raxels within sub-raxel array 410 are refracted by tunable microlens array 420 to be imaged at a point 430 away from EDR light field display 400. The location of point 430 may be modified by tuning the focal length of one or more microlenses within tunable microlens array 420 such that light emitted from sub-raxel array 410 may be used to form an image at focal planes over a range of distances away from EDR light field display 400. That is, the tunability of tunable microlens array 420 allows focal plane sweeping to provide an extended depth of range.

Sub-raxel array 410 includes a plurality of sub-raxels 411. In embodiments, sub-raxel array 410 includes a plurality of raxels 415, which of which includes at least two sub-raxels 411. Along at least one of axes A1 and A2, each sub-raxel 411 has a spatial dimension 412 and each raxel 415 has a spatial dimension 416. Tunable microlens array 420 includes a plurality of microlenses 425, each of which has a spatial dimension 426 along at least one of axes A1 and A2. Spatial dimension 426 may exceed at least one of spatial dimension 412 and spatial dimension 416.

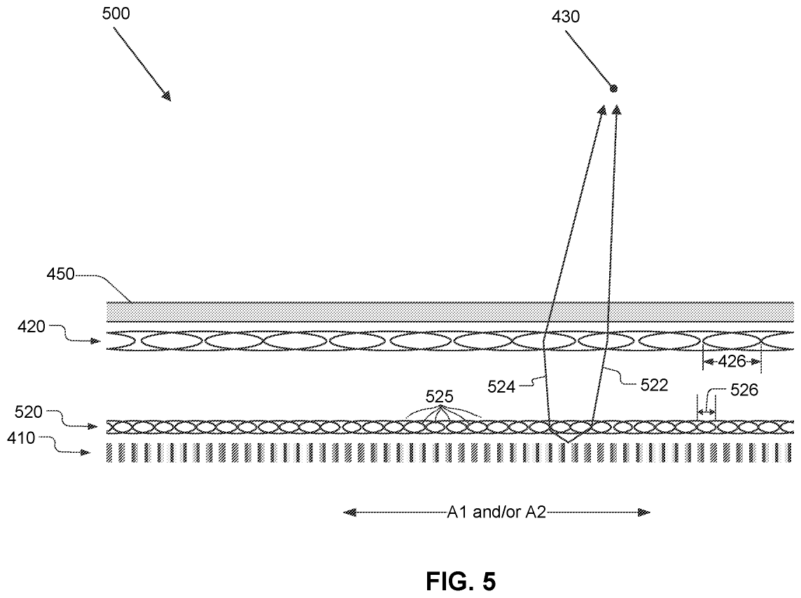

The focal plane tunability (i.e., focal plane sweep) of EDR light field display 400 may be further enhanced, for example, by including a spatial light modulator (SLM) 440 especially in cases when spatial dimension 426 exceeds spatial dimension 416. SLM 440 includes a plurality of SLM pixels 442 that can be individually addressed and modulated. As such, SLM 440 provides additional beam steering functionality to EDR light field display 400 such that, by adjusting one or both of tunable microlens array 420 and SLM 440, EDR light field display 400 is capable of projecting an image from sub-raxel array 410 at a variety of focal planes ranging over, for example, the range of the depth of view zones illustrated in FIGS. 3 and 5 in part or in whole.

In an embodiment, each microlens within tunable microlens array 420 is individually addressable and tunable. In another embodiment, a group of microlenses may be tuned together, rather than each microlens being individually addressed. Each microlens within tunable microlens array 420 may be, for example, the same size as each super-raxel formed from portions of sub-raxel array 410 or larger, such as two to ten times as large as each super-raxel.

Optionally, the microlenses within tunable microlens array 420 may overlap so as to eliminate the effects of any seams that may block or affect light transmitted between the microlenses. For example, while small seams between microlenses (e.g., a few microns between microlenses with a 100-micron diameter) may not be noticeable in the projected image, larger seam-to-lens ratios in the microlens array may result in a window screen-like effect in the viewed image. In this case, an anti-aliasing filter 450 may be included in EDR light field display 400 to mitigate the effects of the lens seams in the imaging of the light rays over a range of focal planes. In an embodiment, anti-aliasing filter 450 is tunable to enable varying the anti-aliasing effect across the anti-aliasing filter aperture or in specific areas of the anti-aliasing filter.

SLM 440 may be formed of, for example, an array of electrically or optically addressable liquid crystal cells. The distance d between sub-raxel array 410 and tunable microlens array 420 may be fixed by, for instance, an appropriate spacer mechanism. Alternatively, distance d may also be tunable, such as using a piezoelectric mechanism or other movable arrangement, to provide a macro-level adjustment of the depth of view. For instance, a piezoelectric mechanism may be used to scan distance d over a specified range and frequency to provide time-based scanning of the depth of view. While FIG. 4 shows light emission from sub-raxel array 410 being transmitted through tunable microlens array 420, anti-aliasing filter 450, then SLM 440 in traveling to point 430, the order of the components encountered by the light rays may be rearranged, in an embodiment.

While the use of larger microlenses within tunable microlens array 420 may provide greater range of tuning while overcoming the diffraction limit, larger lenses have difficulty imaging to focal planes in the near-field zones near the display. In these near-field zones, SLM 440 may be used as, for example, a variable aperture device to compensate for the limitations of the lens and provide clear images in the near-field zones. Thus, by tuning the microlenses within tunable microlens array 420 at a high enough speed, while SLM 440 acts as a variable aperture when imaging to focal planes near the display, EDR light field display 400 effectively presents a 3D image to the viewer over a larger range of depth than possible with conventional devices.

The embodiment illustrated in FIG. 4 may be referred to as a dual-layer display (DLD) architecture for an EDR light field display due to the use of tunable microlens array 420 layered with SLM 440 to provide the extended depth of view. In an approach similar to the integral imaging described above, SLM 440 provides tunable beam steering to direct light provided by sub-raxel array 410 to different locations. Furthermore, tunable microlens array 420 also provides focal plane sweeping of the images produced at sub-raxel array 410 in a manner similar to the multi-focal plane approach also described above. Thus, the DLD architecture combines the attributes of the integral imaging and multi-focal plane approaches while overcoming deficiencies of both.

The DLD architecture illustrated in FIG. 4 can also provide additional advantages. For example, EDR light field display 400 can provide enhanced local dimming by controlling the light emission from the light-emitting elements within sub-raxel array 410 or the throughput or beam steering of SLM 440. That is, in projecting an image with dark features, the light-emitting elements corresponding to those dark features may be locally reduced to enhance the black level of the dark features. Additionally, tunable microlens array 420 and/or SLM 440 may be adjusted to ensure light emission from sub-raxel array 410 do not reach those areas on the focal plane corresponding to the dark features in the image.

Turning now to FIG. 5, another example of an EDR light field display is illustrated, in accordance with an embodiment. Like EDR light field display 400 of FIG. 4, an EDR light field display 500 of FIG. 5 includes sub-raxel array 410, tunable microlens array 420, and, in embodiments, an anti-aliasing filter 450 to mitigate potential issues related to the presence of seams between microlenses in tunable microlens array 420. Rather than an SLM, EDR light field display 500 includes a nanolens array 520.

Nanolens array 520 includes a plurality of microlenses 525, each of which has a spatial dimension 526 along at least one of axes A1 and A2. Spatial dimension 526 is smaller than spatial dimension 426 of microlens 425 and closer in size to spatial dimension 416 of raxels 415 formed from organized groups of sub-raxels 411 of sub-raxel array 410. One or both of tunable microlens array 420 and nanolens array 520 may be independently tunable, and each microlens within tunable microlens array 420 and/or each nanolens within nanolens array 520 may be independently addressable and tunable. For instance, as previously described with respect to EDR light field display 400 of FIG. 4, tunable microlens array 420 provides angular control over the projection of light emitted from sub-raxel array 410 as in the integral imaging approach to light field displays.

In an embodiment, nanolens array 520 is tunable to direct and focus the light emitted from sub-raxel array 410 from different angles to different areas of tunable microlens array 420, thus enabling the imaging of finer features in the near-field zones than possible with the microlens or nanolens array alone and overcoming the diffraction limit. For example, light emitted from sub-raxel array 410 may be focused by nanolens array 520 at or out of the plane of tunable microlens array 420 such that tunable microlens array 420 may image the light over a larger range of focal planes than possible by the microlens alone, as represented by rays 522 and 524. In a sense, nanolens array 520 can be considered to create variable-sized apertures, thus providing images of different sizes as desired to tunable microlens array 420 for projection at a specified focal plane. Since the combination of tunable microlens array 420 and nanolens array 520 acts as two sets of integral imaging systems, the implementation illustrated in FIG. 5 may be referred to as a double-integral-imaging (DII) light field display, in contrast to the DLD architecture described above with respect to FIG. 4.

Tunable microlens array 420 and nanolens array 520 may be formed of a tunable material, such as a liquid crystal material, which exhibits a tunable refractive index by the application of appropriate voltages across the material. The electrode arrangement for the application of the voltage may be formed of, for example, a transparent conductive material, which is transparent in the visible electromagnetic wavelengths. As an example, a printed pattern of transparent electrodes formed of, for example, transparent conductive oxide (TCO) may be used to modify the refractive indices in different areas of each microlens or nanolens (e.g., in a concentric pattern) such that the refractive effect provided by that microlens or nanolens may be tuned accordingly. For instance, rings or stripes of TCO patterns can be used to effect adjustable Fresnel rings or grating structures using tunable microlens array 420 and/or nanolens array 520 to optically affect the light rays transmitted therethrough. Further, by modifying the applied voltages as well as the pattern of the transparent electrodes, each microlens or nanolens may be configured to effectively act as, for instance, a convex lens a concave lens, and graded index lens.

In terms of the light field function analysis discussed with respect to FIG. 4, the light field function corresponding to each focal plane in a DLD architecture for each microlens depends position (p) and ray angle (r) such that the light field function may be resolved as:

L(p,r)=Lₚ(p)·Lᵣ(r) [Eq. 1]

In a DLD architecture, the light emitting elements within each raxel within sub-raxel array 410 as well as SLM 440 in FIG. 4 may be independently controlled such that SLM 440 affects the position-dependent portion Lₚ(p) of the light field function while the light emitting elements affect the angle-dependent portion Lᵣ(r) of the light field function. Image processing algorithms, such as a compressive display algorithm, can be used to take advantage of this decomposition, as well as additional redundancy between focal planes to perform an optimization, such as a non-negative matrix decomposition or other known methods. Alternatively, different raxels can be assigned to different focal planes to simplify the image display algorithm.

The foregoing is illustrative of the various embodiments and is not construed as limiting thereof. Although a few exemplary embodiments have been described, those skilled in the art will readily appreciate that many modifications are possible in the exemplary embodiments without materially departing from the teachings and advantages described herein. For example, with respect to the SLM in the DLD architecture, a relatively high bandwidth may be needed for focus sweeping (e.g., on the order of kHz for a 4 D range with 0.2 D steps). Additional modifications, such as strobing, overdrive, and liquid crystal materials with faster response times (e.g., blue-phase liquid crystals and ferroelectric liquid crystals) may be used to obtain the necessary sweeping speeds.

As another example, lens vignetting may be an issue for tunable microlens array 420 in both DLD and DII light field display architectures, leading to an intensity variation within a multi-pixel lens array. Lens vignetting may be mitigated, for example, overlapping the microlenses in two layers, or the overlay of a gradient neutral density filter to reduce the transmitted light intensity in the middle of each microlens. Additionally, compound lens design or advanced fabrication processes for producing arrays of high quality optics may be used.

A compressive image display algorithm may be used in DLD light field display architecture. A variety of compressive algorithms are available, and the light field data encoding format may be optimized for use with the compressive algorithm. In contrast, DII light field display architecture does not necessary require a compressive algorithm, as this approach already combines aspects or attributes of multi-plane focusing, integral imaging, and a compressive light field.

While embodiments described above are shown with the various components (e.g., raxel array, microlens array, SLM, nanolens array, and anti-aliasing filter) are shown as being layered structures (e.g., as shown in FIGS. 4 and 5), it is recognized that there are a variety of ways to fabricate the EDR light field display embodiments discussed herein. For example, each combination of components (e.g., a raxel and a microlens) may be formed as individual units then arrayed together, the combinations of components may be contemporaneously or serially formed on a single template, or techniques such as wafer-scale fabrication of multiple light-emitting elements or lenses and wafer-scale assembly of the light field display may be used.

Accordingly, although the present disclosure has been provided in accordance with the implementations shown, one of ordinary skill in the art will readily recognize that there could be variations to the embodiments and those variations would be within the scope of the present disclosure. Therefore, many modifications may be made by one of ordinary skill in the art without departing from the scope of the appended

1. A light field display for providing multiple light field views to a viewer, comprising:
a sub-raxel array including a plurality of sub-raxels;
a microlens array in optical communication with the sub-raxel array, the microlens array including a plurality of tunable microlenses; and
a spatial light modulator (SLM) in optical communication with the microlens array,
wherein a dimension of each one of the plurality of tunable microlenses is larger than a corresponding dimension of each one of the plurality of sub-raxels.

2. The light field display of claim 1, wherein the microlens array is located between the sub-raxel array and the SLM.

3. The light field display of claim 1, wherein a light field view produced by the sub-raxel array is projected at a focal plane selected within a first range of depth of view that is wider than an unmodified depth of view provided when each of the plurality of tunable microlenses is not tunable.

4. The light field display of claim 3, wherein the SLM is tunable such that an image produced by the sub-raxel array can be projected over a second range of depth of view, the second range of depth of view being wider than the first range of depth of view.

5. The light field display of claim 3, wherein tuning the each of the plurality of tunable microlenses enables moving the focal plane within the first range of depth of view.

6. The light field display of claim 1, further comprising an anti-aliasing filter layer disposed on either side of the SLM, the anti-aliasing filter layer being configured for mitigating adverse imaging effects due to a presence of seams between the plurality of tunable microlenses within the microlens array.

7. The light field display of claim 6, wherein the anti-aliasing filter layer is tunable.

8. The light field display of claim 1, wherein each one of the plurality of tunable microlenses at least partially overlaps with an adjacent one of the plurality of tunable microlenses.

9. The light field display of claim 1, wherein a gap between adjacent pairs of the plurality of tunable microlenses is smaller than about 1 arcmin as seen by the viewer.

10. A light field display for providing multiple light field views, comprising:
a sub-raxel array;
a nanolens array in optical communication with the sub-raxel array, the nanolens array including a plurality of tunable nanolenses each having a first aperture; and
a microlens array in optical communication with the nanolens array, the microlens array including a plurality of tunable microlenses each having a second aperture that exceeds the first aperture;
wherein, in a first direction, a spatial dimension of each one of the plurality of tunable microlenses is larger than a spatial dimension of each one of a plurality of sub-raxels of the sub-raxel array.

11. The light field display of claim 10, wherein the nanolens array is located between the sub-raxel array and the microlens array.

12. The light field display of claim 10 wherein the sub-raxel array, the nanolens array, and the microlens array are configured for cooperating such that at least one light field view produced by the sub-raxel array is projected at a focal plane selected within a first range of depth of view, the first range of depth of view being wider than an unmodified depth of view provided when the nanolens array and the plurality of tunable microlenses is not tunable.

13. The light field display of claim 12, further comprising an anti-aliasing filter layer configured for mitigating adverse imaging effects due to a presence of seams between the plurality of tunable microlenses within the microlens array.

14. The light field display of claim 13, wherein the anti-aliasing filter layer is tunable.

15. The light field display of claim 12, wherein each one of the plurality of tunable microlenses at least partially overlaps an adjacent one of the plurality of tunable microlenses.

16. The light field display of claim 12, wherein a gap between adjacent pairs of the plurality of tunable microlenses is smaller than about 1 arcmin as seen by a viewer.

17. The light field display of claim 12, wherein a size of each one of the plurality of tunable microlenses is larger than a size of each one of the plurality of tunable nanolenses.

18. The light field display of claim 12, wherein tuning the nanolens array and the microlens array enables moving the focal plane within the first range of depth of view.

19. A method for providing multiple light field views to a viewer, comprising:
producing a light field view with a light field display that includes a plurality of tunable microlenses; and
projecting the light field view at a focal plane selected within a first depth of view that is wider than an unmodified depth of view provided when each of the plurality of tunable microlenses is not tunable.

20. The method of claim 19, further comprising: projecting an image produced by the light field display over a second depth of view that exceeds the first depth of view.

21. The method of claim 19, further comprising moving the focal plane within the first depth of view by tuning each the plurality of tunable microlenses.
